(19) United States
(12) Patent Application Publication
(10) Pub. No.: US 2020/0252386 A1
(43) Pub. Date: Aug. 6, 2020

(54) USER AUTHENTICATION BY ENCODED ACCOUNT INFORMATION

(71) Applicant: Capital One Services, LLC, McLean, VA (US)

(72) Inventors: Abdelkadar M'Hamed BENKREIRA, Washington, DC (US); Michael Mossoba, Arlington, VA (US); Joshua Edwards, Philadelphia, PA (US)

(21) Appl. No.: 16/266,851

(22) Filed: Feb. 4, 2019

(51) Int. Cl. H04L 29/06; G06Q 30/02

(52) U.S. Cl. CPC H04L 63/0807; H04L 2463/082; G06Q 30/0281; H04L 63/0892

(57) ABSTRACT

A device detects a communication, to a customer support center and initiated by a user device of a user via a first communication channel, after a request is initiated by the user and via a second communication channel that is different from the first communication channel, to receive customer support. The device obtains, after the user is authenticated to access a user account via the second communication channel and after obtaining first information that includes first account information from the user account, authentication data, from the communication, that encodes the first information. The device identifies the first information based on decoding the authentication data, and obtains second information, associated with the user, that includes second account information from the user account. The device authenticates the user for access to the user account during the communication based on determining that the first account information matches the second account information.

### BACKGROUND

An authentication process may be performed to verify an identity of an individual. For example, when the individual contacts a customer support center of an entity regarding an account maintained by the entity, the customer support center may authenticate the individual to verify that the individual is associated with the account and not a third party attempting to gain fraudulent access to the account.

### SUMMARY

According to some implementations, a method may include detecting, by a device, a communication to a customer support center initiated by a user device of a user via a first communication channel, wherein the communication to the customer support center is detected after a request is initiated, by the user and via a second communication channel, to receive customer support, and wherein the first communication channel is different from the second communication channel. The method may include obtaining, by the device, authentication data from the communication, wherein the authentication data is obtained after the user is authenticated to access a user account of the user via the second communication channel and first information associated with the user is obtained, wherein the first information includes first account information from the user account, and wherein the authentication data encodes the first information. The method may include identifying, by the device, the first information based on decoding the authentication data, and obtaining, by the device, second information associated with the user, wherein the second information includes second account information from the user account. The method may include determining, by the device, whether the first account information matches the second account information, and authenticating, by the device, the user for access to the user account during the communication to the customer support center based on determining that the first account information matches the second account information.

According to some implementations, a device may include one or more memories, and one or more processors, communicatively coupled to the one or more memories, to receive, from a first device, a request that includes first account information from a user account of a user, wherein the request is received after the user is authenticated to access the user account by the first device via a first communication channel. The one or more processors may generate authentication data that encodes the first account information, and transmit, to the first device, a first response containing the authentication data, wherein the first response is transmitted to permit the first device to transmit the authentication data to a user device of the user. The one or more processors may receive, from a second device, the authentication data, wherein the authentication data is received after the user device initiates a communication to a customer support center via a second communication channel and transmits the authentication data during the communication to the customer support center to the second device, and wherein the second communication channel is different from the first communication channel. The one or more processors may identify the first account information based on decoding the authentication data, and may transmit, to the second device, a second response containing the first account information, wherein the second response is transmitted to permit the second device to authenticate the user to access the user account during the communication to the customer support center based on determining that the first account information matches second account information obtained from the user account by the second device.

According to some implementations, a non-transitory computer-readable medium may store instructions that include one or more instructions that, when executed by one or more processors of a device, cause the one or more processors to receive, from a first device, a request that includes first account information from a user account of a user, wherein the request is received after the user is authenticated to access the user account by the first device via a first communication channel. The one or more instructions may cause the one or more processors to generate a token, and store the token in association with the first account information. The one or more instructions may cause the one or more processors to generate authentication data that encodes the token, and transmit, to the first device, a first response containing the authentication data, wherein the first response is transmitted to permit the first device to transmit the authentication data to a user device of the user. The one or more instructions may cause the one or more processors to receive, from a second device, the authentication data, wherein the authentication data is received after the user device initiates a communication to a customer support center via a second communication channel and transmits the authentication data during the communication to the customer support center to the second device, wherein the second communication channel is different from the first communication channel. The one or more instructions may cause the one or more processors to identify the token based on decoding the authentication data, and obtain the first account information that is associated with the token. The one or more instructions may cause the one or more processors to transmit, to the second device, a second response containing the first account information, wherein the second response is transmitted to permit the second device to authenticate the user to access the user account during the communication to the customer support center based on determining that the first account information matches second account information obtained from the user account by the second device.

### BRIEF DESCRIPTION OF THE DRAWINGS

FIGS. 1A and 1B are diagrams of one or more example implementations described herein.

FIG. 2 is a diagram of an example implementation described herein.

FIG. 3 is a diagram of an example environment in which systems and/or methods, described herein, may be implemented.

FIG. 4 is a diagram of example components of one or more devices of FIG. 3.

FIG. 5-7 are flow charts of example processes for user authentication by encoded account information.

### DETAILED DESCRIPTION

The following detailed description of example implementations refers to the accompanying drawings. The same reference numbers in different drawings may identify the same or similar elements.

A user may contact a customer support center of an entity via a phone call or a video call regarding an account maintained by the entity (e.g., a member account, a financial account, and/or the like). In many instances, a representative of the customer support center authenticates the user to verify that the user is associated with the account and not a fraudulent actor attempting to gain unlawful access to the account. In such cases, to authenticate the user, the representative may ask the user to verify authentication information (e.g., account information associated with the account, such as an address associated with the account, a social security number associated with the account, etc.). If the user provides authentication information that matches the information of the account, the representative may authenticate the user and enable the user to access information associated with the account and/or perform an action associated with the account.

Sometimes, prior to contacting the customer support center, the user may seek customer support through a website associated with the entity (e.g., by an instant messaging interface associated with the website, by a customer support portal associated with the website, by a user account area of the website, and/or the like). In such cases, the user may be required to provide authentication information to receive customer support via the website or to access an account via the website. When the user later contacts the customer support center, the representative repeats the authentication process. Accordingly, the authentication process performed by the representative is unnecessary and wastes the time and computing resources of the customer support center because the user was already authenticated.

Furthermore, an authentication process that takes place over a phone call or a video call requires the user to verbally share the authentication information (e.g., account information) in a manner that can be overheard by a third party. Additionally, if the representative has fraudulent intentions, the representative may acquire the authentication information for fraudulent use (e.g., to gain access to the user's account). Therefore, using previous techniques for authentication via a representative, a user's account and/or personal information may be put at risk to potentially fraudulent activity.

Accordingly, authentication performed by the representative of the customer support center wastes computing resources (e.g., processing resources, memory resources, and/or the like) and/or network resources involved in authenticating a user that has been previously authenticated. Additionally, authentication that requires users to verbally share account information can expose user accounts to fraud, thereby causing millions or billions of dollars in additional expenses for the entity that maintains the user accounts as well as wasting computing and network resources involved in identifying, investigating, and/or correcting fraudulent activity.

Some implementations described herein provide a secure system for authenticating a user, that was previously authenticated via a first communication channel (e.g., a communication channel associated with a website, a mobile application, and/or the like), during a communication to a customer support center via a second communication channel (e.g., a communication channel associated with a phone call, a video call, and/or the like). As described herein, the user may provide authentication information via the first communication channel, and once authenticated, the user may request authentication data (e.g., audio data that encodes account information of the user, graphical data that encodes account information of the user, and/or the like) to provide during the communication to the customer support center via the second communication channel. According to some implementations, a user device of the user may provide the authentication data during the communication to the customer support center and the authentication data may be processed by a device associated with the customer support center to authenticate the user to access a user account during the communication to the customer support center.

In this way, once the user has been authenticated in a first communication channel, an additional authentication step that involves sharing account information (e.g., verbally sharing account information) with a representative of a customer support center can be eliminated. Accordingly, computing resources (e.g., processing resources, memory resources, and/or the like) and/or network resources associated with the authentication of the user by the representative (e.g., computing resources and/or network resources associated with longer call durations, multiple call transfers, looking up authentication information, etc.) may be conserved. Furthermore, fraudulent activity that is made possible by verbally sharing account information may be reduced, thereby conserving computing resources (e.g., processing resources, memory resources, and/or the like) and/or network resources involved in identifying, investigating, and/or correcting fraudulent activity. Additionally, eliminating the additional authentication process provides an improved user experience in that the user may receive customer support more expeditiously while avoiding the tedium of sharing multiple items of account information with one or more representatives.

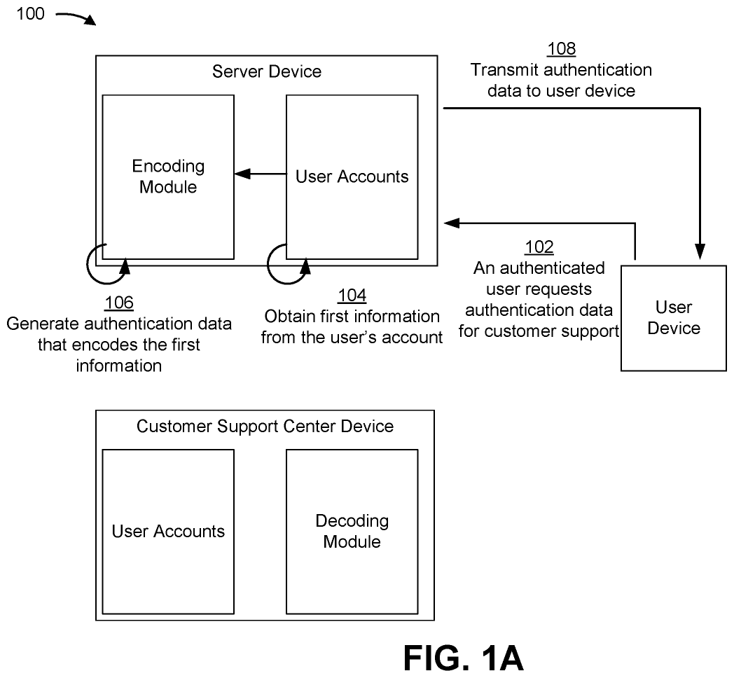

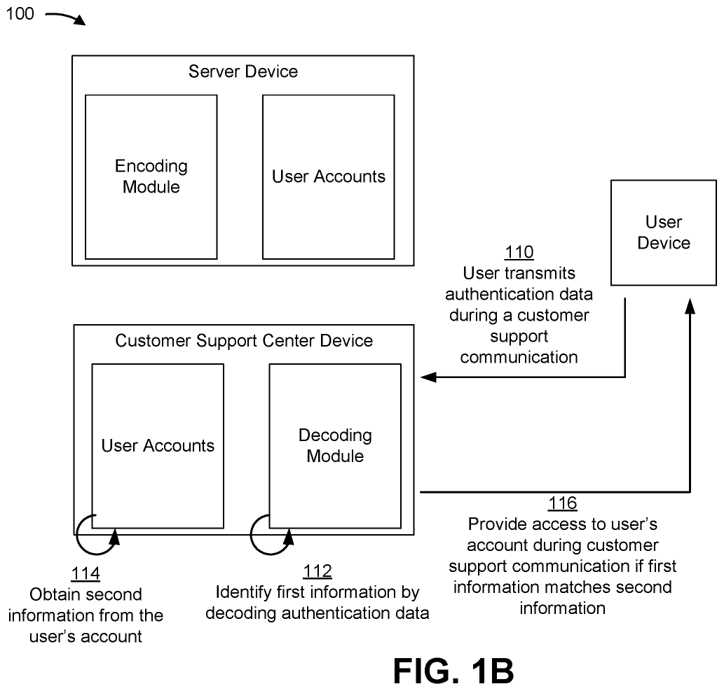

FIGS. 1A and 1B are diagrams of one or more example implementations 100 described herein. As shown in FIGS. 1A and 1B, example implementation(s) 100 may include a user device (e.g., a smartphone, a tablet computer, a laptop computer, a desktop computer, and/or the like) associated with a user in need of customer support from an entity in connection with a user account of the user that is maintained by the entity. For example, the user may be a customer that maintains a user account (e.g., a checking account, a savings account, a credit account, a shopping account, an entertainment account, etc.) with the entity (e.g., a financial institution, a merchant, an entertainment provider, etc.), and that is in need of customer support relating to a matter in connection with the user account (e.g., updating account information associated with the user account, adding or removing an additional user from the user account, receiving a status of the user account (e.g., a balance of the user account, a recent activity of the user account, etc.), reporting fraud associated with the user account, and/or the like).

As described herein, prior to initiating a communication to a customer support center of the entity, the user may have been authenticated to access the user account by a first device (e.g., a web server device associated with a website, a mobile application, etc.) via a first communication channel. While the description to follow will describe the first device in terms of a server device, the description is not limited to this particular example. Implementations described herein also apply to other types of devices that may authenticate a user and generate, or request, authentication data, such as a transaction terminal (e.g., a point of sale (PoS) terminal, an automated teller machine (ATM) terminal, and/or the like), a user device (e.g., a smartphone, a tablet computer, a laptop computer, a desktop computer, etc.), and/or the like.

In response to a request (e.g., a request to receive customer support) from the user device of the authenticated user, the first device may generate, and transmit to, the user device, authentication data that encodes account information from the user account of the user (e.g., audio data that encodes account information from the user account). As described herein, a second device (e.g., a device associated with a customer support center) may obtain the authentication data during the communication between the user device and the customer support center, and, based on the authentication data, determine whether to permit the user to access the user account during the communication to the customer support center.

In some implementations, the first device and the second device may be associated with an entity, such as a financial institution, that provides customer support to users that maintain an account with the entity.

As shown in FIG. 1A, and by reference number 102, the user device of the user may transmit to a server device, or cause the server device to obtain, via a first communication channel, a request for authentication data that may be used to authenticate the user during a communication to a customer support center via a second communication channel. In some implementations, the request may be triggered by one or more actions performed by the user on the user device (e.g., entering, or selecting, a command in an application executing on the user device, requesting content from the server device, such as a contact information webpage, and/or the like).

In some implementations, the first communication channel is different from the second communication channel. In some implementations, the first communication channel may be a non-voice communication channel, a non-video communication channel, or a non-voice and non-video communication channel. For example, data, other than voice data or video data, may be communicated via the first communication channel, such as data associated with a website or a mobile application.

In some implementations, the second communication channel may be a voice communication channel or a video communication channel. For example, voice data and/or video data may be communicated via the second communication channel by a phone call (e.g., a phone call via a landline, a phone call via a cellular network, a phone call via voice over Internet Protocol (VoIP), and/or the like) and/or a video call (e.g., a video call via a cellular network, a video call via the Internet, a video call via an integrated services digital network (ISDN), and/or the like).

In some implementations, prior to transmitting the request for authentication data, the user may have been authenticated by the server device, via the first communication channel, to access the user account (e.g., by an application (e.g., a website, a mobile application, and/or the like) associated with the server device). For example, the user may have been authenticated by the server device by an authentication procedure, such as authentication by a username and password combination, authentication by a personal identification number (PIN), authentication by a biometric identifier (e.g., a fingerprint), authentication using two-step authentication, and/or the like. In some implementations, the user may have been authenticated by a device other than the server device (e.g., the user device of the user), and information that identifies the user as being authenticated may be communicated to the server device.

As shown by reference number 104, the server device may obtain account information from the user account of the user. For example, after verifying that the user is authenticated, the server device may access the user account of the user and obtain account information from the user account. In some implementations, the account information may relate to a portion of a name of the user, a portion of an address of the user, a portion of a social security number of the user, a portion of a transaction card identification string of the user, a security question answer of the user (e.g., a favorite movie of the user, a city of birth of the user, a first car of the user, and/or the like) and/or the like. In some implementations, the user account of the user, in connection with the first communication channel, may be stored in a data structure (e.g., a database, a linked list, a table, and/or the like) that is associated with the server device, or another device that communicates with the server device.

As shown by reference number 106, the server device, using an encoding function (e.g., a text-to-audio encoding function, a text-to-barcode encoding function, a text-to-image encoding function, etc.), may generate authentication data that encodes authentication information relating to the user, the user account, the user device, the request for customer support, the authentication data (e.g., metadata), and/or the like. In some implementations, the authentication information includes the account information from the user account of the user that is obtained by the server device. Additionally, or alternatively, the authentication information may include a verification code (e.g., a sequence of numbers or alphanumeric characters) generated by the server device and/or associated with the user account of the user.

In some implementations, the authentication data may be audio data (e.g., an audio file), graphical data (e.g., a quick response (QR) code), a verification code, a passphrase, and/or the like. For example, the authentication data may be audio data that encodes the authentication information in an audio signal (e.g., a dual-tone multi-frequency (DTMF) signal) that includes a series of pitches and/or tones that are determined by the particular authentication information being encoded. As another example, the authentication data may be graphical data that encodes the authentication information in a barcode, a matrix barcode (e.g., QR code), an image, a video, and/or the like.

In some implementations, the authentication information may include an expiration time for the authentication data (e.g., a timestamp, or another indicator, of a future time when the authentication data expires and may not be used to authenticate the user). For example, the expiration time may indicate that the authentication data may not be used to authenticate the user upon an expiration of 10 minutes, 1 hour, 24 hours, etc. after the authentication data was generated. Additionally, or alternatively, the authentication information may include a use limit for the authentication data. For example, the use limit may indicate that the authentication data may be used to authenticate the user a single time, two times, five times, etc. In this way, even if the authentication data is intercepted by a third party (e.g., intercepted during transmission of the authentication data from the user device to the customer support center), the ability of the third party to use the authentication data for fraudulent purposes is reduced, thereby conserving computing resources and/or network resources that would otherwise be wasted in identifying, investigating, and/or correcting the fraudulent activity.

In some implementations, the authentication information may include customer support information that relates to a matter for which the user is requesting customer support. For example, the customer support information may include a description of the matter for which the user is requesting customer support (e.g., “I would like to add another user to my account”), a search phrase entered by the user (e.g., “problem making a payment”), an identifier of a type of customer support the user is requesting (e.g., “balance check”), an identifier of a terminal of the customer support center that is associated with a particular representative (e.g., an extension of the representative), and/or the like. In some implementations, the customer support information may be included in the request for authentication data transmitted by the user device (e.g., the user may enter, or select, customer support information in connection with initiating the request for authentication data), or may have been previously communicated by the user to the server device (e.g., the user may have previously entered customer support information in connection with the user seeking customer support through the server device, such as through a website associated with the server device (e.g., a search phrase entered in the website)). In this way, the communication to the customer support center may be simplified by eliminating a step in which the user provides a reason for seeking customer support to one or more representatives, thereby conserving computing resources and/or network resources associated with longer call durations, multiple call transfers, navigating a customer support user interface, etc.

In some implementations, the server device may not generate the authentication data and may transmit an instruction to the user device that causes the user device to generate the authentication data, or a portion of the authentication data. For example, the server device may transmit an instruction (e.g., an instruction that includes authentication information, such as account information and/or a verification code) that causes the user device (e.g., via an application executing on the user device, such as a mobile application) to generate authentication data (e.g., audio data or graphical data) based on the instruction (e.g., based on the authentication information). Additionally, or alternatively, the user device may generate authentication data based on information input by the user to the user device (e.g., the user may input information, such as a social security number, an address, a verification code, etc. to an application of the user device) and/or by information stored by, or relating to, the user device (e.g., a social security number stored by the user device, an address stored by the user device, a unique identifier of the user device (e.g., a media access control (MAC) address), and/or the like).

In some implementations, the server device may not generate the authentication data and may transmit a request to a credentialing platform to generate the authentication data, or a portion of the authentication data. The credentialing platform may be associated with a device (e.g., a server device) and include an application programming interface (API) that responds to requests for authentication data. In some implementations, the server device may transmit a request (e.g., a request that includes authentication information) to the credentialing platform, and the credentialing platform may generate authentication data based on the request (e.g., based on the authentication information) and transmit the authentication data to the server device.

In some implementations, the authentication data generated by the credentialing platform may not encode the authentication information included in the request from the server device and may encode a token that is associated (e.g., in a data structure, such as a database, a linked list, a table, and/or the like) with the authentication information. In this way, the authentication data does not contain sensitive authentication information (e.g., account information) that may be intercepted by a third party (e.g., intercepted during a transmission of the authentication data from the user device to the customer support center) and used for fraudulent activity, thereby conserving computing resources and/or network resources that would otherwise be wasted in identifying, investigating, and/or correcting the fraudulent activity.

In some implementations, the token also may be associated (e.g., in a data structure, such as a database, a linked list, a table, and/or the like) with an expiration time or a use limit, as described above.

In some implementations, the authentication information may be encrypted prior to being encoded in the authentication data. For example, the authentication information may be encrypted by an encryption function (e.g., an encryption function that employs a data encryption standard (DES) technique, a triple-DES technique, an advanced encryption standard (AES) technique, and/or the like) associated with the server device or the credentialing platform to obtain encrypted authentication information. Continuing with the previous example, the server device or the credentialing platform may generate authentication data that encodes the encrypted authentication information.

As shown by reference number 108, the server device may transmit, or make available, the authentication data (e.g., the authentication data generated by the server device or the authentication data generated by the credentialing platform and transmitted to the server device) to the user device. For example, the server device may transmit, or make available, a file that contains the authentication data (e.g., a file of audio data, a file of graphical data, etc.). As another example, the server device may transmit, or cause the user device to display, a notification (e.g., a notification on a web page, a notification on a mobile application, a notification on the user device, etc.) that provides the authentication data (e.g., a message or an alert that provides a verification code or a passphrase) to the user.

In some implementations, such as where the user device generated the authentication data, the user device may generate the file that contains the authentication data (e.g., by a mobile application of the user device) or display the notification that provides the authentication data to the user.

As shown by FIG. 1B, and by reference number 110, after obtaining the authentication data, the user device may initiate a communication to a customer support center (e.g., the user device may place a phone call, a video call, etc. to the customer support center), via a second communication channel, and transmit the authentication data during the communication. For example, if the authentication data is audio data, the user device may transmit the audio data by playing the audio data (e.g., through a speaker of the user device) or transferring the audio data (e.g., transferring the audio data as a signal over a telecommunications system) during a communication with the customer support center, such as a phone call. As another example, if the authentication data is graphical data, the user device may transmit the graphical data by displaying the graphical data (e.g., by a display of the user device) to a camera (e.g., a webcam, a videophone, a camera integrated with a user device, and/or the like) or transferring the graphical data (e.g., transferring the graphical data as a signal over a telecommunications system) during a communication with the customer support center, such as a video call. As a further example, if the authentication data is a verification code (e.g., a sequence of numbers), the user may transmit the verification code as audio data (e.g., DTMF (also known as touch-tone) data) via the user device by entering the verification code in an interface of the user device (e.g., a telephone keypad interface).

In this way, the user may avoid the need to verbally share authentication information with a representative during a phone call or a video call to a customer support center, thereby providing a more efficient and secure authentication procedure that may conserve computing resources and/or network resources associated with the authentication of the user by the representative (e.g., computing resources and/or network resources associated with longer call durations, multiple call transfers, etc.) and associated with identifying, investigating, and/or correcting fraudulent activity that may otherwise occur.

In some implementations, a customer support center device associated with the customer support center may detect the communication from the user device to the customer support center and monitor the communication for a transmission of the authentication data by the user device. For example, the customer support center device may monitor the communication for an audio signal (e.g., a tone or a sequence of tones) or a graphical indicia that is recognized by the customer support center device as being associated with the transmission of authentication data. In some implementations, the customer support center device may obtain the authentication data from the communication for further processing.

As shown by reference number 112, the customer support center device, using a decoding function (e.g., an audio-to-text decoding function, a barcode-to-text decoding function, an image-to-text decoding function, etc.), may identify the authentication information (e.g., the account information) from the authentication data by decoding the authentication data. For example, the customer support center device may decode a series of pitches and/or tones of audio data into textual data (e.g., machine-encoded text data) that includes the authentication information. As another example, the customer support center device may decode a barcode from graphical data into textual data (e.g., machine-encoded text data) that includes the authentication information.

In some implementations, the customer support center device may not decode the authentication data and may transmit a request to the credentialing platform to decode the authentication data. For example, the customer support center device may transmit a request (e.g., a request that includes the authentication data) to the credentialing platform, and the credentialing platform may identify the authentication information by decoding the authentication data and transmit the authentication information to the customer support center device.

In some implementations, the credentialing platform may identify a token by decoding the authentication data or may receive a token that was decoded from the authentication data by the customer support center device. In such implementations, the credentialing platform may obtain (e.g., from a data structure) the authentication information associated with the token (e.g., account information, an expiration time, and/or customer support information) and transmit the authentication information to the customer support center device.

In some implementations, prior to transmitting the authentication information to the customer support center device, the credentialing platform may determine whether an expiration time of the authentication information, or an expiration time associated with the token, is expired. For example, the credentialing platform may determine that the expiration time is expired and may transmit a response to the customer support center device that does not include the account information and/or that identifies the authentication data as invalid.

In some implementations, the authentication information may be decrypted after being decoded from the authentication data. For example, the authentication information may be decrypted by a decryption function associated with the customer support center device or the credentialing platform to obtain decrypted authentication information.

As shown by reference number 114, the customer support center device may obtain account information from the user account of the user for comparison to the account information identified in the authentication data (e.g., the account information identified by the customer support center device or the account information identified by the credentialing platform and transmitted to the customer support center device). In some implementations, the user account of the user, in connection with the second communication channel, may be stored in a data structure (e.g., a database, a linked list, a table, and/or the like) that is associated with the customer support center device, or another device that communicates with the customer support center device. In some implementations, the data structure may be associated with a device that communicates with the server device and the customer support center device.

In some implementations, the customer support center device may determine a user account from which to obtain account information for comparison based on one or more parameters of the communication from the user device. For example, the customer support center device may determine a parameter of the user device (e.g., a phone number of the user device, an Internet Protocol (IP) address of the user device, a MAC address of the user device, and/or the like) and, based on the parameter, determine a user account from which to obtain account information for comparison. Additionally, or alternatively, the authentication information may contain information (e.g., a user identification number, an account number, etc.) that identifies the user account from which the customer support center device is to obtain account information for comparison.

As shown by reference number 116, the customer support center device may authenticate the user for access to the user account during the communication to the customer support center based on determining that the account information obtained by the customer support center device from the user account matches the account information identified from the authentication data. For example, the customer support center device may determine whether first account information identified from the authentication data matches second account information obtained from the user account by the customer support center device. In some implementations, the account information obtained by the customer support center device from the user account may match (e.g., entirely match or partially match (e.g., a partial match that satisfies a threshold confidence level to authenticate a user)) the account information identified from the authentication data to authenticate the user.

In some implementations, the customer support center device may terminate the communication to the customer support center without authenticating the user for access to the user account, or may request additional information from the user, based on determining that the account information obtained by the customer support center device from the user account does not match the account information identified from the authentication data. In some implementations, the customer support center device may terminate the communication to the customer support center without authenticating the user for access to the user account, or may request additional information from the user, based on determining that an expiration time of the authentication information is expired.

In some implementations, the customer support center device may perform additional operations in connection with the communication after authenticating the user. In some implementations, such as where the authentication information includes customer support information relating to the matter for which the user is requesting customer support, the customer support center device may perform one or more actions based on the customer support information. For example, the customer support center device may route the communication to a terminal of the customer support center that is associated with a representative equipped to provide a type of customer support indicated by the customer support information. As another example, the customer support center device may cause a terminal of the customer support center to display one or more prompts or one or more instructions for handling a type of customer support indicated by the customer support information. As an additional example, the customer support center device may obtain, from one or more sources (e.g., the Internet, internal customer support documentation, and/or the like), information relating to a type of customer support indicated by the customer support information, and may cause a terminal of the customer support center to display the information. As a further example, the customer support center device may cause a terminal of the customer support center to display a notification of a description of a matter for which the user is requesting customer support that is included in the customer support information.

In some implementations, the customer support center device may perform the one or more actions prior to the communication being connected to a representative of the customer support center. In this way, the representative may have an opportunity to review the matter for which the user is requesting customer support before interacting with the user, thereby providing a more efficient customer support interaction that may conserve computing resources and/or network resources (e.g., computing resources and/or network resources associated with longer call durations, multiple call transfers, looking up customer support information, etc.)

In some implementations, the authenticated user may be granted access to the user account to receive information associated with the user account (e.g., receive an account balance associated with the user account, receive a report of recent activity associated with the user account, and/or the like), change information of the user account (e.g., change an address of the user account, change a payment method of the user account, and/or the like), report an event relating to the user account (e.g., report fraudulent activity associated with the user account, report a lost or a stolen transaction card associated with the user account, and/or the like), add or remove an additional user for the user account, and/or the like.

In some implementations, the access granted to the user may be terminated when the communication from the user device to the customer support center is terminated. In some implementations, the access granted to the user may persist during a time period (e.g., 1 hour, 24 hours, 1 week, etc.) and may be terminated after the time period. For example, the access granted to the user may persist for the time period provided that a second communication to the customer support center initiated by the user is made by a user device that initiated a first communication to the customer support center in which the user was authenticated.

As indicated above, FIGS. 1A and 1B are provided merely as an example. Other examples may differ from what was described with regard to FIGS. 1A and 1B.

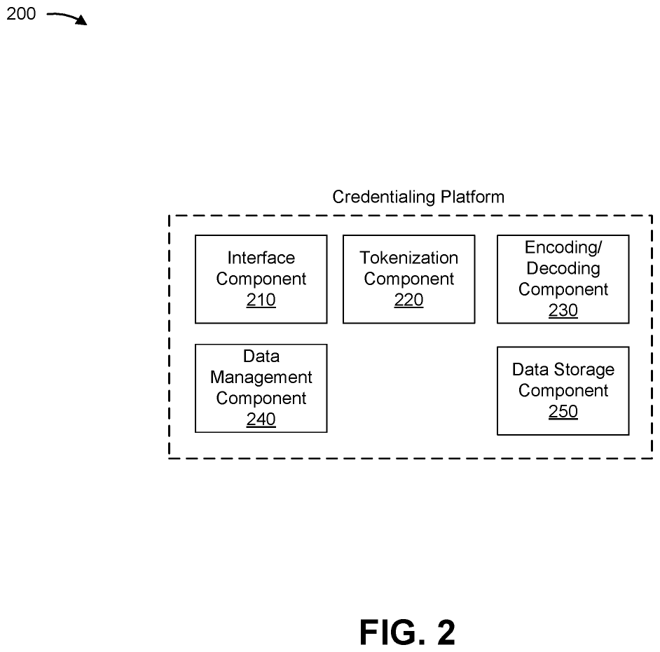

FIG. 2 is a diagram of an example implementation 200 described herein. FIG. 2 shows example components of the credentialing platform described above. In some implementations, the credentialing platform may include interface component 210, tokenization component 220, encoding/decoding component 230, data management component 240, and data storage component 250.

The credentialing platform may receive a first request (e.g., an API request) from a first device (e.g., a web server device) to encode authentication data for authentication information associated with a user that is authenticated by the first device. In response, the credentialing platform may associate the authentication information with a token, generate authentication data that encodes the token, and transmit the authentication data to the first device. Additionally, the credentialing platform may receive a second request (e.g., an API request) from a second device (e.g., a customer support center device) to decode the authentication data to permit the second device to authenticate the user. In response, the credentialing platform may decode the authentication data to identify the token, determine the authentication information associated with the token, and transmit the authentication information to the second device.

As shown in FIG. 2, the credentialing platform may include an interface component 210. For example, interface component 210 may receive a request to generate authentication data that encodes authentication information and transmit a response to the request that contains the authentication data. As another example, interface component 210 may receive a request to decode authentication data that encodes authentication information and transmit a response to the request that contains the authentication information. In some implementations, interface component 210 is an API (e.g., a representational state transfer (RESTful) web service).

As also shown in FIG. 2, the credentialing platform may include tokenization component 220. For example, tokenization component 220 may obtain authentication information (e.g., from interface component 210) and generate a token that is stored in association with the authentication information (e.g., by data storage component 250). In some implementations, tokenization component 220 may generate an expiration time (e.g., a timestamp, or another indicator, of a future time when the token expires and may not be used to authenticate the user) that is stored in association with the token (e.g., by data storage component 250). As an additional example, tokenization component 220 may obtain a token (e.g., from encoding/decoding component 230), obtain authentication information associated with the token (e.g., from data storage component 250), and transmit the authentication information (e.g., to interface component 210). In some implementations, tokenization component 220 may obtain an expiration time that is associated with a token (e.g., from data storage component 250), determine whether the expiration time is expired, and transmit a notification of an invalid token (e.g., to interface component 210) based on determining that the expiration time is expired.

As further shown in FIG. 2, the credentialing platform may include an encoding/decoding component 230. For example, encoding/decoding component 230 may generate authentication data (e.g., audio data, graphical data, and/or the like) that encodes a token (e.g., a token generated by tokenization component 220). As another example, encoding/decoding component 230 may decode authentication data (e.g., authentication data received from interface component 210) to identify a token encoded by the authentication data.

As also shown in FIG. 2, the credentialing platform may include a data management component 240. For example, the credentialing platform may use data management component 240 to receive, store, process, modify, access, and/or the like data (e.g., authentication information, a token, an expiration time, and/or the like), as described herein. As further shown in FIG. 2, the credentialing platform can include a data storage component 250. For example, data storage component 250 can include a data structure used to store data, and/or the like.

As indicated above, FIG. 2 is provided merely as an example. Other examples can differ from what was described with regard to FIG. 2. The number and arrangement of components shown in FIG. 2 are provided as an example. In practice, the credentialing platform can include additional components, fewer components, different components, or differently arranged components than those shown in FIG. 2. Additionally, or alternatively, a set of components (e.g., one or more components) of the credentialing platform can perform one or more functions described as being performed by another set of components of the credentialing platform.

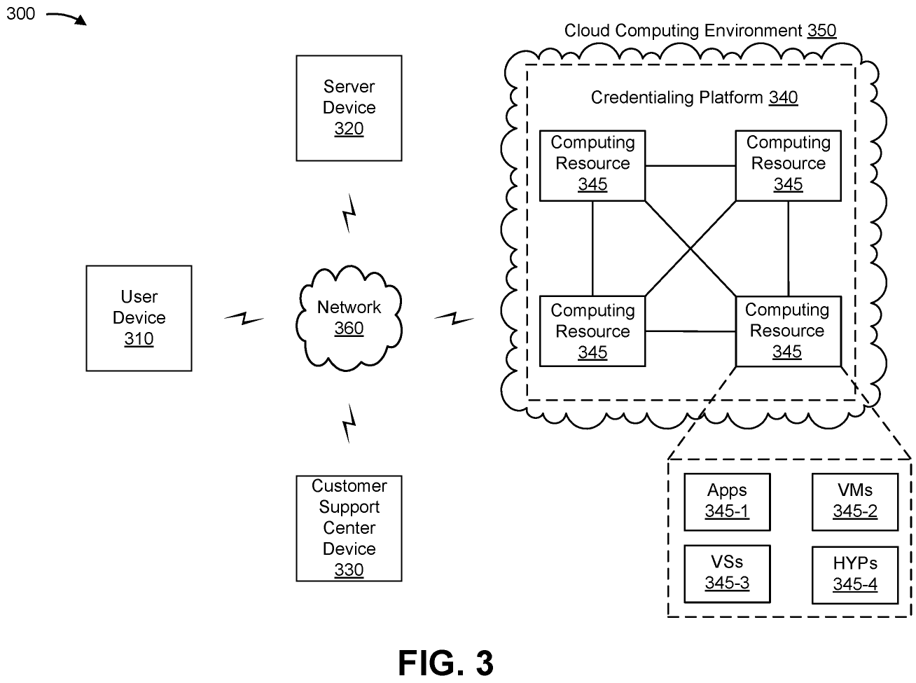

FIG. 3 is a diagram of an example environment 300 in which systems and/or methods, described herein, may be implemented. As shown in FIG. 3, environment 300 may include a user device 310, a server device 320, a customer support center device 330, a credentialing platform 340, a computing resource 345, a cloud computing environment 350, and a network 360. Devices of environment 300 may interconnect via wired connections, wireless connections, or a combination of wired and wireless connections.

User device 310 includes one or more devices capable of receiving, generating, storing, processing, and/or providing information associated with user authentication by encoded account information. For example, user device 310 may include a communication and/or computing device, such as a mobile phone (e.g., a smartphone, a radiotelephone, etc.), a laptop computer, a desktop computer, a tablet computer, a handheld computer, a gaming device, a wearable communication device (e.g., a smart wristwatch, a pair of smart eyeglasses, etc.), an internet of things (IoT) device or smart appliance, or a similar type of device.

Server device 320 includes one or more devices capable of receiving, generating, storing, processing, and/or providing information, such as information described herein. For example, server device 320 may be a web server device associated with a website or a mobile application, and may include a laptop computer, a tablet computer, a desktop computer, a server device, a group of server devices, or a similar type of device. In some implementations, server device 320 may authenticate a user (e.g., authentication by a username and password combination) via a first communication channel (e.g., a non-voice and/or a non-video communication channel), receive a request from the user for customer support via a second communication channel (e.g., a voice and/or a video communication channel), and transmit authentication data to the user that encodes authentication information from a user account of the user. In some implementations, server device 320 may receive information from, and/or transmit information to, user device 310, customer support center device 330, and/or credentialing platform 340.

Customer support center device 330 includes one or more devices capable of receiving, generating, storing, processing, and/or providing information, such as information described herein. For example, customer support center device 330 may include a computing device (e.g., a laptop computer, a tablet computer, a desktop computer, a server device, a group of server devices, and/or the like) associated with a telephony system or a videotelephony system of a customer support center. In some implementations, customer support center device 330 may detect a communication from user device 310 to a customer support center via a second communication channel (e.g., a voice and/or a video communication channel), monitor the communication for authentication data transmitted by user device 310, obtain authentication information encoded by the authentication data, and authenticate the user based on the authentication information. In some implementations, customer support center device 330 may receive information from, and/or transmit information to, user device 310, server device 320, and/or credentialing platform 340.

Credentialing platform 340 includes one or more computing resources assigned to encode and/or decode authentication data associated with user authentication. For example, credentialing platform 340 may be a platform implemented by cloud computing environment 350 that may receive a first request that includes authentication information, generate a token associated with the authentication information, generate authentication data that encodes the token, and transmit the authentication data in response to the first request. Additionally, credentialing platform 340 may receive a second request that includes the authentication data, identify the token based on decoding the authentication data, determine the authentication information associated with the token, and transmit the authentication information in response to the second request. In some implementations, one or more (or all) functions of credentialing platform 340 are implemented by user device 310, server device 320, and/or customer support center device 330. In some implementations, one or more (or all) functions of credentialing platform 340 are implemented by computing resources 345 of cloud computing environment 350.

Credentialing platform 340 may include a server device or a group of server devices. In some implementations, credentialing platform 340 may be hosted in cloud computing environment 350. Notably, while implementations described herein describe credentialing platform 340 as being hosted in cloud computing environment 350, in some implementations, credentialing platform 340 may be non-cloud-based or may be partially cloud-based.

Cloud computing environment 350 includes an environment that delivers computing as a service, whereby shared resources, services, etc. may be provided to user device 310, server device 320, and/or customer support center device 330. Cloud computing environment 350 may provide computation, software, data access, storage, and/or other services that do not require end-user knowledge of a physical location and configuration of a system and/or a device that delivers the services. As shown, cloud computing environment 350 may include credentialing platform 340 and computing resource 345.

Computing resource 345 includes one or more personal computers, workstation computers, server devices, or another type of computation and/or communication device. In some implementations, computing resource 345 may host credentialing platform 340. The cloud resources may include compute instances executing in computing resource 345, storage devices provided in computing resource 345, data transfer devices provided by computing resource 345, etc. In some implementations, computing resource 345 may communicate with other computing resources 345 via wired connections, wireless connections, or a combination of wired and wireless connections.

As further shown in FIG. 3, computing resource 345 may include a group of cloud resources, such as one or more applications (“APPs”) 345-1, one or more virtual machines (“VMs”) 345-2, virtualized storage (“VSs”) 345-3, one or more hypervisors (“HYPs”) 345-4, or the like.

Application 345-1 includes one or more software applications that may be provided to or accessed by user device 310, server device 320, and/or customer support center device 330. Application 345-1 may eliminate a need to install and execute the software applications on user device 310, server device 320, and/or customer support center device 330. For example, application 345-1 may include software associated with credentialing platform 340 and/or any other software capable of being provided via cloud computing environment 350. In some implementations, one application 345-1 may send/receive information to/from one or more other applications 345-1, via virtual machine 345-2.

Virtual machine 345-2 includes a software implementation of a machine (e.g., a computer) that executes programs like a physical machine. Virtual machine 345-2 may be either a system virtual machine or a process virtual machine, depending upon use and degree of correspondence to any real machine by virtual machine 345-2. A system virtual machine may provide a complete system platform that supports execution of a complete operating system (“OS”). A process virtual machine may execute a single program and may support a single process. In some implementations, virtual machine 345-2 may execute on behalf of a user (e.g., user device 310, server device 320, and/or customer support center device 330), and may manage infrastructure of cloud computing environment 350, such as data management, synchronization, or long-duration data transfers.

Virtualized storage 345-3 includes one or more storage systems and/or one or more devices that use virtualization techniques within the storage systems or devices of computing resource 345. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 345-4 provides hardware virtualization techniques that allow multiple operating systems (e.g., “guest operating systems”) to execute concurrently on a host computer, such as computing resource 345. Hypervisor 345-4 may present a virtual operating platform to the guest operating systems and may manage the execution of the guest operating systems. Multiple instances of a variety of operating systems may share virtualized hardware resources.

Network 360 includes one or more wired and/or wireless networks. For example, network 360 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

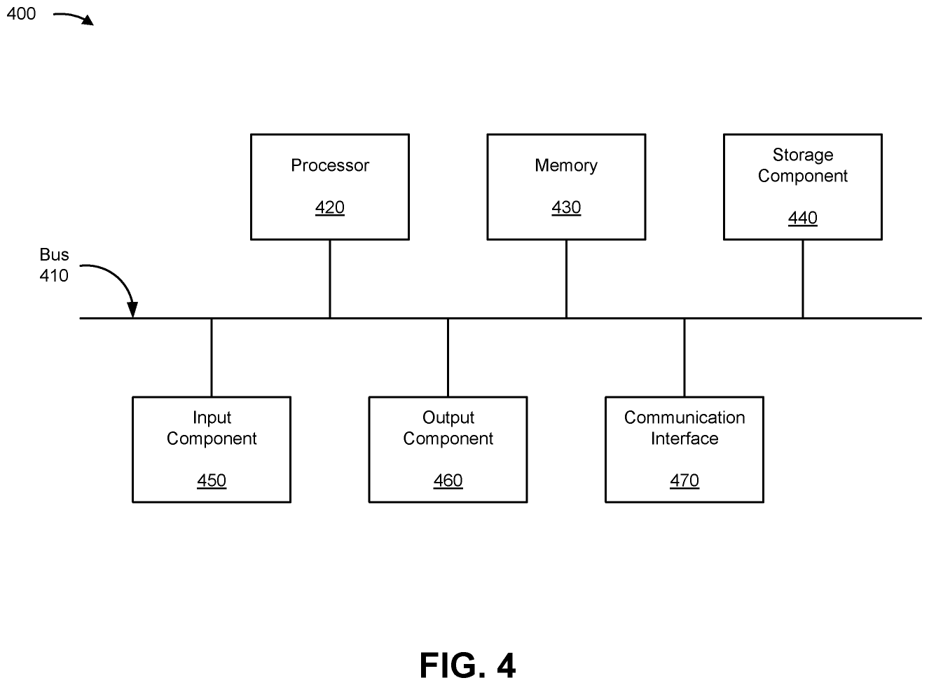

FIG. 4 is a diagram of example components of a device 400. Device 400 may correspond to user device 310, server device 320, customer support center device 330, credentialing platform 340, and/or computing resource 345. In some implementations, user device 310, server device 320, customer support center device 330, credentialing platform 340, and/or computing resource 345 may include one or more devices 400 and/or one or more components of device 400. As shown in FIG. 4, device 400 may include a bus 410, a processor 420, a memory 430, a storage component 440, an input component 450, an output component 460, and a communication interface 470.

Bus 410 includes a component that permits communication among the components of device 400. Processor 420 is implemented in hardware, firmware, or a combination of hardware and software. Processor 420 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of device 400. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 450 includes a component that permits device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 includes a component that provides output information from device 400 (e.g., a display, a speaker, and/or one or more light-emitting diodes (LEDs)).

Communication interface 470 includes a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, or the like.

Device 400 may perform one or more processes described herein. Device 400 may perform these processes based on processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

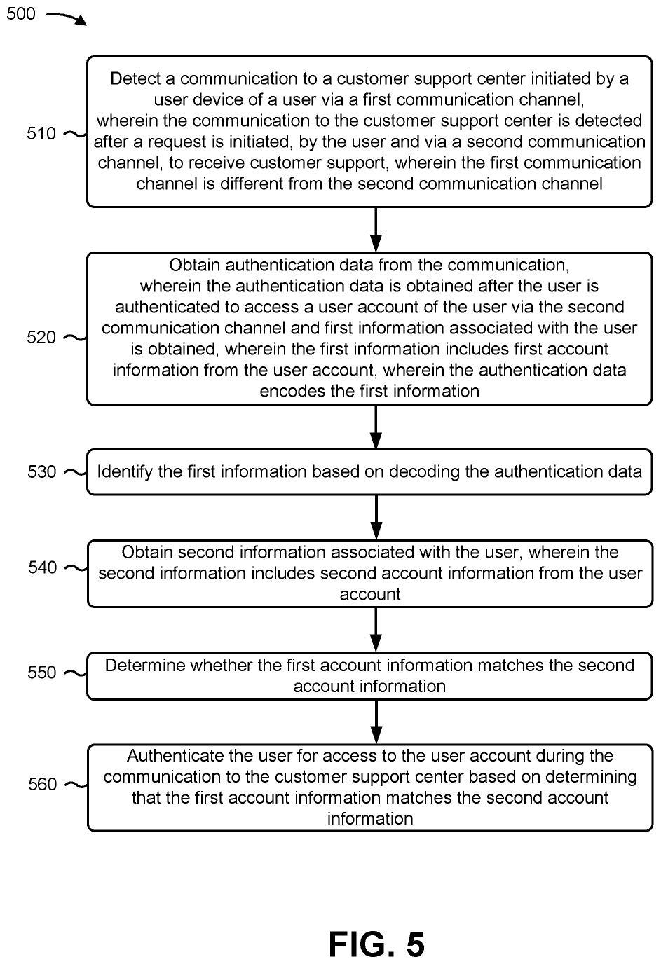

FIG. 5 is a flow chart of an example process 500 for user authentication by encoded account information. In some implementations, one or more process blocks of FIG. 5 may be performed by a customer support center device (e.g., customer support center device 330). In some implementations, one or more process blocks of FIG. 5 may be performed by another device or a group of devices separate from or including a customer support center device (e.g., customer support center device 330), such as a user device (e.g., user device 310), a server device (e.g., server device 320), a credentialing platform (e.g., credentialing platform 340), and a computing resource (e.g., computing resource 345).

As shown in FIG. 5, process 500 may include detecting a communication to a customer support center initiated by a user device of a user via a first communication channel, wherein the communication to the customer support center is detected after a request is initiated, by the user and via a second communication channel, to receive customer support, and wherein the first communication channel is different from the second communication channel (block 510). For example, the customer support center device (e.g., using processor 420, memory 430, storage component 440, input component 450, communication interface 470, and/or the like) may detect a communication to a customer support center initiated by a user device of a user via a first communication channel, as described above. In some implementations, the communication to the customer support center may be detected after a request is initiated, by the user and via a second communication channel, to receive customer support. In some implementations, the first communication channel may be different from the second communication channel.

As further shown in FIG. 5, process 500 may include obtaining authentication data from the communication, wherein the authentication data is obtained after the user is authenticated to access a user account of the user via the second communication channel and first information associated with the user is obtained, wherein the first information includes first account information from the user account, and wherein the authentication data encodes the first information (block 520). For example, the customer support center device (e.g., using processor 420, memory 430, storage component 440, input component 450, communication interface 470, and/or the like) may obtain authentication data from the communication, as described above. In some implementations, the authentication data may be obtained after the user is authenticated to access a user account of the user via the second communication channel and first information associated with the user is obtained. In some implementations, the first information may include first account information from the user account, and the authentication data may encode the first information.

As further shown in FIG. 5, process 500 may include identifying the first information based on decoding the authentication data (block 530). For example, the customer support center device (e.g., using processor 420, memory 430, storage component 440, and/or the like) may identify the first information based on decoding the authentication data, as described above.

As further shown in FIG. 5, process 500 may include obtaining second information associated with the user, wherein the second information includes second account information from the user account (block 540). For example, the customer support center device (e.g., using processor 420, memory 430, storage component 440, input component 450, communication interface 470, and/or the like) may obtain second information associated with the user, as described above. In some implementations, the second information may include second account information from the user account.

As further shown in FIG. 5, process 500 may include determining whether the first account information matches the second account information (block 550). For example, the customer support center device (e.g., using processor 420, memory 430, storage component 440, and/or the like) may determine whether the first account information matches the second account information, as described above.

As further shown in FIG. 5, process 500 may include authenticating the user for access to the user account during the communication to the customer support center based on determining that the first account information matches the second account information (block 560). For example, the customer support center device (e.g., using processor 420, memory 430, storage component 440, input component 450, output component 460, communication interface 470, and/or the like) may authenticate the user for access to the user account during the communication to the customer support center based on determining that the first account information matches the second account information, as described above.

Process 500 may include additional implementations, such as any single implementation or any combination of implementations described below and/or in connection with one or more other processes described elsewhere herein.

In some implementations, the first information may include an identifier of a type of customer support, and the customer support center device may route the communication to a customer support terminal of the customer support center based on the identifier of the type of customer support. In some implementations, the customer support center device may terminate the communication to the customer support center before authenticating the user to access the user account based on determining that the first account information does not match the second account information.

In some implementations, the first account information and the second account information may include a portion of at least one of: a name of the user, an address of the user, a social security number of the user, or a transaction card identification string of the user. In some implementations, the first communication channel may be a voice communication channel and the second communication channel may be a non-voice communication channel. In some implementations, the authentication data that encodes the first information may be audio data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

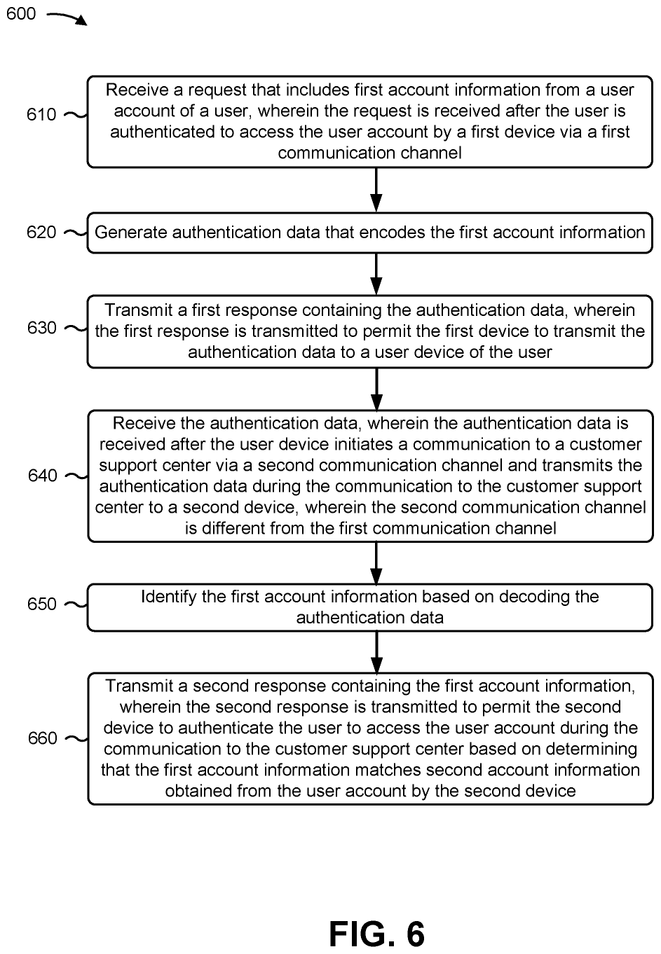

FIG. 6 is a flow chart of an example process 600 for user authentication by encoded account information. In some implementations, one or more process blocks of FIG. 6 may be performed by a credentialing platform (e.g., credentialing platform 340). In some implementations, one or more process blocks of FIG. 6 may be performed by another device or a group of devices separate from or including a credentialing platform (e.g., credentialing platform 340), such as a user device (e.g., user device 310), a server device (e.g., server device 320), a customer support center device (e.g., customer support center device 330), and a computing resource (e.g., computing resource 345).

As shown in FIG. 6, process 600 may include receiving, from a first device, a request that includes first account information from a user account of a user, wherein the request is received after the user is authenticated to access the user account by the first device via a first communication channel (block 610). For example, the credentialing platform (e.g., using computing resource 345, processor 420, memory 430, storage component 440, input component 450, communication interface 470, and/or the like) may receive, from a first device, a request that includes first account information from a user account of a user, as described above. In some implementations, the request may be received after the user is authenticated to access the user account by the first device via a first communication channel.

As further shown in FIG. 6, process 600 may include generating authentication data that encodes the first account information (block 620). For example, the credentialing platform (e.g., using computing resource 345, processor 420, memory 430, storage component 440, and/or the like) may generate authentication data that encodes the first account information, as described above.

As further shown in FIG. 6, process 600 may include transmitting, to the first device, a first response containing the authentication data, wherein the first response is transmitted to permit the first device to transmit the authentication data to a user device of the user (block 630). For example, the credentialing platform (e.g., using computing resource 345, processor 420, memory 430, storage component 440, output component 460, communication interface 470, and/or the like) may transmit, to the first device, a first response containing the authentication data, as described above. In some implementations, the first response may be transmitted to permit the first device to transmit the authentication data to a user device of the user.

As further shown in FIG. 6, process 600 may include receiving, from a second device, the authentication data, wherein the authentication data is received after the user device initiates a communication to a customer support center via a second communication channel and transmits the authentication data during the communication to the customer support center to the second device, and wherein the second communication channel is different from the first communication channel (block 640). For example, the credentialing platform (e.g., using computing resource 345, processor 420, memory 430, storage component 440, input component 450, communication interface 470, and/or the like) may receive, from a second device, the authentication data, as described above. In some implementations, the authentication data may be received after the user device initiates a communication to a customer support center via a second communication channel and transmits the authentication data during the communication to the customer support center to the second device. In some implementations, the second communication channel may be different from the first communication channel.

As further shown in FIG. 6, process 600 may include identifying the first account information based on decoding the authentication data (block 650). For example, the credentialing platform (e.g., using computing resource 345, processor 420, memory 430, storage component 440, and/or the like) may identify the first account information based on decoding the authentication data, as described above.

As further shown in FIG. 6, process 600 may include transmitting, to the second device, a second response containing the first account information, wherein the second response is transmitted to permit the second device to authenticate the user to access the user account during the communication to the customer support center based on determining that the first account information matches second account information obtained from the user account by the second device (block 660). For example, the credentialing platform (e.g., using computing resource 345, processor 420, memory 430, storage component 440, output component 460, communication interface 470, and/or the like) may transmit, to the second device, a second response containing the first account information, as described above. In some implementations, the second response may be transmitted to permit the second device to authenticate the user to access the user account during the communication to the customer support center based on determining that the first account information matches second account information obtained from the user account by the second device.

Process 600 may include additional implementations, such as any single implementation or any combination of implementations described below and/or in connection with one or more other processes described elsewhere herein.

In some implementations, the credentialing platform may encrypt the first account information before generating the authentication data, and may decrypt the first account information after identifying the first account information. In some implementations, when generating authentication data that encodes the first account information, the credentialing platform may generate authentication data that encodes the first account information and an expiration time.

In some implementations, when identifying the first account information based on decoding the authentication data, the credentialing platform may identify the first account information and the expiration time based on decoding the authentication data, may determine whether the expiration time is expired, and may transmit, to the second device, the second response without the first account information based on the expiration time having expired.

In some implementations, the first communication channel may be a non-voice communication channel and the second communication channel may be a voice communication channel. In some implementations, the first device may be a server device associated with a website and the second device may be a computing device associated with a telephony system or a videotelephony system. In some implementations, the first account information and the second account information may include a portion of at least one of: a name of the user, an address of the user, a social security number of the user, or a transaction card identification string of the user.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

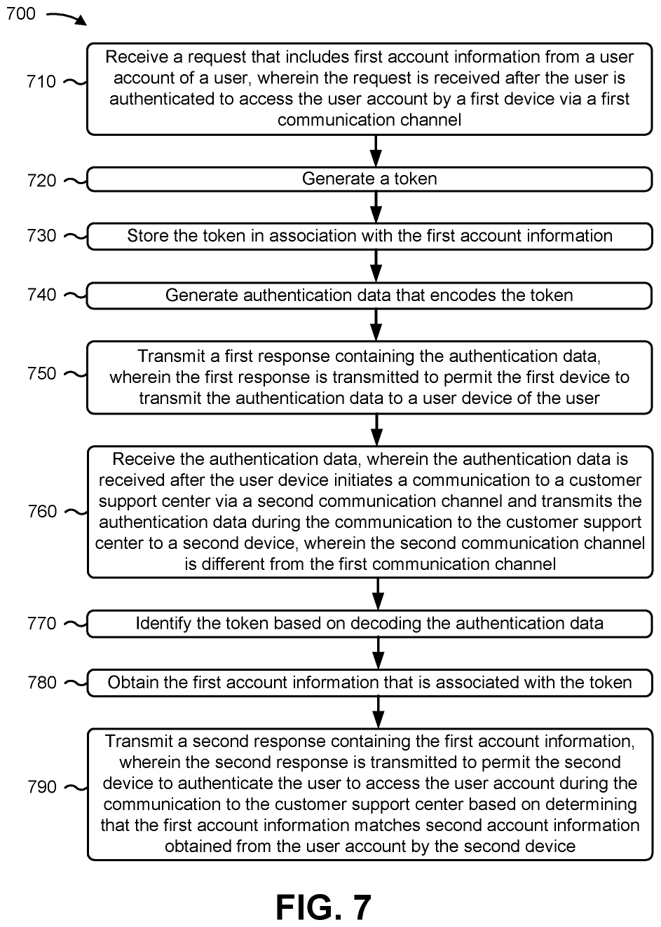

FIG. 7 is a flow chart of an example process 700 for user authentication by encoded account information. In some implementations, one or more process blocks of FIG. 7 may be performed by a credentialing platform (e.g., credentialing platform 340). In some implementations, one or more process blocks of FIG. 7 may be performed by another device or a group of devices separate from or including a credentialing platform (e.g., credentialing platform 340), such as a user device (e.g., user device 310), a server device (e.g., server device 320), a customer support center device (e.g., customer support center device 330), and a computing resource (e.g., computing resource 345).

As shown in FIG. 7, process 700 may include receiving, from a first device, a request that includes first account information from a user account of a user, wherein the request is received after the user is authenticated to access the user account by the first device via a first communication channel (block 710). For example, the credentialing platform (e.g., using computing resource 345, processor 420, memory 430, storage component 440, input component 450, communication interface 470, and/or the like) may receive, from a first device, a request that includes first account information from a user account of a user, as described above. In some implementations, the request may be received after the user is authenticated to access the user account by the first device via a first communication channel.

As further shown in FIG. 7, process 700 may include generating a token (block 720). For example, the credentialing platform (e.g., using computing resource 345, processor 420, memory 430, storage component 440, and/or the like) may generate a token, as described above.

As further shown in FIG. 7, process 700 may include storing the token in association with the first account information (block 730). For example, the credentialing platform (e.g., using computing resource 345, processor 420, memory 430, storage component 440, input component 450, output component 460, communication interface 470, and/or the like) may store the token in association with the first account information, as described above.

As further shown in FIG. 7, process 700 may include generating authentication data that encodes the token (block 740). For example, the credentialing platform (e.g., using computing resource 345, processor 420, memory 430, storage component 440, and/or the like) may generate authentication data that encodes the token, as described above.

As further shown in FIG. 7, process 700 may include transmitting, to the first device, a first response containing the authentication data, wherein the first response is transmitted to permit the first device to transmit the authentication data to a user device of the user (block 750). For example, the credentialing platform (e.g., using computing resource 345, processor 420, memory 430, storage component 440, output component 460, communication interface 470, and/or the like) may transmit, to the first device, a first response containing the authentication data, as described above. In some implementations, the first response may be transmitted to permit the first device to transmit the authentication data to a user device of the user.

As further shown in FIG. 7, process 700 may include receiving, from a second device, the authentication data, wherein the authentication data is received after the user device initiates a communication to a customer support center via a second communication channel and transmits the authentication data during the communication to the customer support center to the second device, and wherein the second communication channel is different from the first communication channel (block 760). For example, the credentialing platform (e.g., using computing resource 345, processor 420, memory 430, storage component 440, input component 450, communication interface 470, and/or the like) may receive, from a second device, the authentication data, as described above. In some implementations, the authentication data may be received after the user device initiates a communication to a customer support center via a second communication channel and transmits the authentication data during the communication to the customer support center to the second device. In some implementations, the second communication channel may be different from the first communication channel.

As further shown in FIG. 7, process 700 may include identifying the token based on decoding the authentication data (block 770). For example, the credentialing platform (e.g., using computing resource 345, processor 420, memory 430, storage component 440, and/or the like) may identify the token based on decoding the authentication data, as described above.

As further shown in FIG. 7, process 700 may include obtaining the first account information that is associated with the token (block 780). For example, the credentialing platform (e.g., using computing resource 345, processor 420, memory 430, storage component 440, input component 450, output component 460, communication interface 470, and/or the like) may obtain the first account information that is associated with the token, as described above.

As further shown in FIG. 7, process 700 may include transmitting, to the second device, a second response containing the first account information, wherein the second response is transmitted to permit the second device to authenticate the user to access the user account during the communication to the customer support center based on determining that the first account information matches second account information obtained from the user account by the second device (block 790). For example, the credentialing platform (e.g., using computing resource 345, processor 420, memory 430, storage component 440, output component 460, communication interface 470, and/or the like) may transmit, to the second device, a second response containing the first account information, as described above. In some implementations, the second response may be transmitted to permit the second device to authenticate the user to access the user account during the communication to the customer support center based on determining that the first account information matches second account information obtained from the user account by the second device.

Process 700 may include additional implementations, such as any single implementation or any combination of implementations described below and/or in connection with one or more other processes described elsewhere herein.

In some implementations, when storing the token in association with the first account information, the credentialing platform may store the token in association with the first account information and an expiration time. In some implementations, the first communication channel may be a non-video communication channel and the second communication channel may be a video communication channel. In some implementations, the authentication data may be a quick response code. In some implementations, the first communication channel may be a non-voice communication channel and the second communication channel may be a voice communication channel. In some implementations, the authentication data may be audio data.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, or the like.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

1. A method, comprising:
detecting, by a customer support device, a communication to a customer support center initiated by a user device of a user via a first communication channel between the user device and the customer support center,
wherein the communication to the customer support center is detected after a request is initiated, by the user device and via a second communication channel between the user device and a server device, to receive customer support,
wherein the first communication channel is different from the second communication channel;
obtaining, by the customer support device and from the user device, authentication data that comprises graphical data that encodes first account information associated with the user,
wherein the graphical data includes a graphic determined based on the first account information, and
wherein the authentication data is obtained, by the customer support device, after the user was authenticated, by the server device, to access a user account of the user via the second communication channel and after the first account information was encoded by the server device,
identifying, by the customer support device, the first account information based on decoding the authentication data;
obtaining, by the customer support device, second information associated with the user,
wherein the second information includes second account information from the user account;
determining, by the customer support device, whether the first account information matches the second account information; and
authenticating, by the customer support device, the user for access to the user account during the communication to the customer support center based on determining that the first account information matches the second account information.

2. The method of claim 1, wherein the first account information further includes an identifier of a type of customer support,
wherein the method further comprises:
routing the communication to a customer support terminal of the customer support center based on the identifier of the type of customer support.

3. The method of claim 1, further comprising:
terminating the communication to the customer support center before authenticating the user to access the user account based on determining that the first account information does not match the second account information.

4. The method of claim 1, wherein the first account information and the second account information include a portion of at least one of:
a name of the user,
an address of the user,
a social security number of the user, or
a transaction card identification string of the user.

5. The method of claim 1, wherein the first communication channel is a voice communication channel and the second communication channel is a non-voice communication channel.

6. (canceled)

7. The method of claim 1, wherein access to the user account during the communication to the customer support center includes one or more of:
access to receive information of the user account,
access to change information of the user account, or
access to report events relating to the user account.

8. A server device, comprising:
one or more memories; and
one or more processors, communicatively coupled to the one or more memories, to:
receive, from a user device, a request that includes first account information from a user account of a user,
wherein the request is received after the user is authenticated to access the user account by the server device via a first communication channel;
determine a graphic based on the first account information;
generate graphical data that comprises the graphic and encodes the first account information;
generate authentication data that comprises the graphical data,
transmit, to the user device, a first response containing the authentication data,
wherein the first response is transmitted to permit the user device to transmit the authentication data to a customer support device associated with a customer support center;
receive, from the customer support device, the authentication data,
wherein the authentication data is received after the user device initiates a communication to the customer support center via a second communication channel and transmits the authentication data during the communication to the customer support device,
wherein the second communication channel is different from the first communication channel;
identify the first account information based on decoding the graphic data included in the authentication data; and
transmit, to the customer support device, a second response containing the first account information,
wherein the second response is transmitted to permit the customer support device to authenticate the user to access the user account during the communication to the customer support center based on determining that the first account information matches second account information obtained from the user account by the customer support device.

9. The server device of claim 8, wherein the one or more processors are further to:
encrypt the first account information before generating the authentication data; and
decrypt the first account information after identifying the first account information.

10. The server device of claim 8, wherein the one or more processors, when generating authentication data that encodes the first account information, are to:
generate authentication data that encodes the first account information and an expiration time.

11. The server device of claim 10, wherein the one or more processors, when identifying the first account information based on decoding the authentication data, are to:
identify the first account information and the expiration time based on decoding the authentication data;
determine whether the expiration time is expired; and
transmit, to the customer support device, the second response without the first account information based on the expiration time having expired.

12. The server device of claim 8, wherein the first communication channel is a non-voice communication channel and the second communication channel is a voice communication channel.

13. The server device of claim 8, wherein the server device is associated with a website and the customer support device is a computing device associated with a telephony system or a videotelephony system.

14. The server device of claim 8, wherein the first account information and the second account information include a portion of at least one of:
a name of the user,
an address of the user,
a social security number of the user, or
a transaction card identification string of the user.

15. A non-transitory computer-readable medium storing instructions, the instructions comprising:
one or more instructions that, when executed by one or more processors of a server device, cause the one or more processors to:
receive, from a user device, a request that includes first account information from a user account of a user,
wherein the request is received after the user is authenticated, by the server device and via a first communication channel, to access the user account;
determine a graphic based on the first account information;
generate graphical data that comprises the graphic and encodes the first account information;
generate authentication data that comprises the graphical data;
transmit, to the user device, a first response containing the authentication data,
wherein the first response is transmitted to permit the user device to transmit the authentication data to a customer support device;
receive, from the customer support device, the authentication data,
wherein the authentication data is received after the user device initiates a communication to a customer support center via a second communication channel and transmits the authentication data during the communication to the customer support device,
wherein the second communication channel is different from the first communication channel;
identify the first account information based on decoding the graphic data included in the authentication data;
obtain the first account information that is associated with the graphic; and
transmit, to the customer support device, a second response containing the first account information,
wherein the second response is transmitted to permit the customer support device to authenticate the user to access the user account during the communication to the customer support center based on determining that the first account information matches second account information obtained from the user account by the customer support device.

16. The non-transitory computer-readable medium of claim 15, wherein the one or more instructions, when executed by the one or more processors, further cause the one or more processors to:
store the graphic in association with the first account information and an expiration time.

17. The non-transitory computer-readable medium of claim 15, wherein the first communication channel is a non-video communication channel and the second communication channel is a video communication channel.

18. (canceled)

19. The non-transitory computer-readable medium of claim 15, wherein the first communication channel is a non-voice communication channel and the second communication channel is a voice communication channel.

20. (canceled)

21. The non-transitory computer-readable medium of claim 15, wherein the first account information and the second account information include a portion of at least one of:
a name of the user,
an address of the user,
a social security number of the user, or
a transaction card identification string of the user.

22. The non-transitory computer-readable medium of claim 15, wherein:
the graphic is stored in association with the first account information and an expiration time; and
the one or more instructions, that cause the one or more processors to identify the graphic based on decoding the graphic data included in the authentication data, cause the one or more processors to:
identify the graphic and the expiration time based on decoding the graphic data;
determine whether the expiration time is expired; and
transmit, to the customer support device, the second response without the first account information based on the expiration time having expired.

23. The method of claim 1, further comprising:
encrypting the first account information before generating the authentication data; and
decrypting the first account information after identifying the first account information.
